(19) United States
(12) Patent Application Publication
(10) Pub. No.: US 2005/0094091 A1
(43) Pub. Date: May 5, 2005

(54) Assembling structure of a pair of glasses

(76) Inventor: Chia Hao Hsu, Nantou County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/968,898

(22) Filed: Oct. 21, 2004

(30) Foreign Application Priority Data
Oct. 31, 2003 (TW) 92219459

(51) Int. Cl. G02C 1/02

(52) U.S. Cl. 351/110

(57) ABSTRACT

An assembling structure of a pair of glasses, including two lenses, a bridge, two connecting brackets, two connecting butts and two temples. The inner and outer sides of each lens are respectively formed with a first slot and a second slot. The bridge is fixedly inserted in the first slots of the lenses for interconnecting the lenses. The connecting brackets are fixedly inserted in the second slots and connected with the connecting butts. The temples are pivotally connected with the connecting butts.

### BACKGROUND OF THE INVENTION

The present invention is related to an improved assembling structure of a pair of glasses, and more particularly to an assembling structure of a pair of rimless glasses for more simply and firmly assembling the lenses with the bridge and the temples. Moreover, the assembling structure is able to keep the lenses in a true position.

FIG. 9 shows a pair of conventional rimless glasses in which the bridge and temples are directly assembled with the lenses. The inner side and outer side of each lens 7 are respectively formed with two slots 71. The bridge 8 is made of a steel wire which is bent to form two U-shaped extension sections 81 for fixedly fitting through the inner slots 71 of the lenses 7. The bridge 8 has two nosepieces 82 for resting on two sides of the nose of a user. The temples 9 via two lens butts 91 are connected with outer sides of the lenses 7. Each lens butt 91 is made of a steel wire which is bent to form a U-shaped extension section 911 and a connecting section 912. The extension section 911 is fixedly fitted through the outer slot 71 of each lens 7. The temple 9 is connected with the connecting section 912. Each temple 9 is made of a steel wire which is bent to form a coil at one end for fitting on the connecting section 912 of the lens butt 91. The other end of the temple 9 is bent into a hook shape for hanging on a user's ear. Accordingly, a user can wear the rimless glasses in front of his/her eyes.

When wearing the glasses, the lenses are kept parallel to the user's eyes. The lower edge of the lens must be spaced from the eye by a distance about the width of a finger. Conventionally, as shown in FIG. 10, the angle contained between the lenses 7 and the eyes and the distance between the lenses 7 and the eyes are adjustable by means of adjusting the nosepieces 82. However, the configurations of the noses of different users vary. Therefore, it is hard to adjust the position of the lenses 7 well simply by means of adjusting the nosepieces 82. Moreover, the nosepieces 82 tend to displace due to external force. As a result, it is often necessary to again adjust the position of the lenses 7. Furthermore, the nosepieces 82 are often rested on the nose of the user for a long time. This will make the user's nose feel uncomfortable.

In addition, one end of the temple 9 is bent into a coil which is simply pivotally connected with the connecting section 912 of the lens butt 91 so that the temple 9 tends to loosen. Also, no stopper structure is disposed between the temple 9 and the lens butt 91 so that the temple 9 is often over-stretched outward. This makes the user unable to stably wear the rimless glasses on his/her face.

### SUMMARY OF THE INVENTION

It is therefore a primary object of the present invention to provide an improved assembling structure of a pair of glasses, including:
two lenses, two adjacent inner sides of the lenses being respectively formed with two first slots, the distal outer sides of the lenses being respectively formed with two second slots;
a bridge made of a metal slender rod by bending, the bridge having an arced transverse beam on which a slipproof sleeve is fitted, two ends of the transverse beam being bent to form two U-shaped insertion sections for fixedly fitting through the first slots of the lenses, whereby the two lenses are interconnected by the bridge;
two connecting brackets, each connecting bracket being made of a metal slender rod by bending, one end of the connecting bracket being bent to form a U-shaped fixing section for fixedly fitting through the second slot of the lens, the other end of the connecting bracket being bent to form a U-shaped connecting end, a bight section of the U-shaped connecting end forming a stopper section;
two connecting butts, each connecting butt being formed with a transverse first connecting hole and a longitudinal second connecting hole, the first connecting hole being formed on outer side of the connecting butt, while the second connecting hole being formed on inner side of the connecting butt, a free end of the connecting end of the connecting bracket being fixedly fitted in the first connecting hole, whereby the connecting butt is fixed with the connecting end of the connecting bracket; and
two temples, each temple being made of a metal slender rod by bending, one end of the temple being bent to form a longitudinal fitting section for fitting into the second connecting hole of the connecting butt, whereby the temple is pivotally connected with the connecting butt, the other end of the temple being bent into a hook section for hanging on a user's ear, a section of the temple near the fitting section being stoppable by the stopper section of the connecting end of the connecting bracket.

With respect to a common person, the distances between the trough portion A and the eyes are equal. Therefore, when the transverse beam 21 of the bridge 2 is bridged over the trough portion A between the nose and the forehead of the user, the distance between the lenses 1 and the eyes will not change. Also, it is no more necessary to adjust the nosepieces according to the configuration of the nose as in the conventional glasses. Therefore, it is easy to wear the lenses 1 in a true position. Moreover, the user can wear the lenses 1 on his/her face without the nosepieces so that the uncomfortableness caused by the nosepieces can be eliminated.

It is a further object of the present invention to provide the above assembling structure of the glasses in which the first connecting holes are formed on outer sides of the connecting butts, while the second connecting holes are formed on inner sides of the connecting butts. Therefore, when assembling the connecting brackets with the temples, the temples are positioned on inner sides of the connecting brackets. Accordingly, the bodies of the temples are stopped by the stopper sections of the connecting ends of the connecting brackets. Therefore, the temples will not be over-stretched outward so that the user can stably wear the glasses.

It is still a further object of the present invention to provide the above assembling structure of the glasses in which the insertion section of the bridge and the fixing section of the connecting bracket both have stopper ends. Therefore, when assembled, the insertion section and the fixing section will not entirely penetrate through the slots of the lenses.

It is still a further object of the present invention to provide the above assembling structure of the glasses in which the temples are connected with the connecting brackets via the connecting butts. Accordingly, the lenses can be assembled with the temples with higher strength and firmness. Therefore, the user can more stably wear the glasses.

The present invention can be best understood through the following description and accompanying drawings wherein:

### BRIEF DESCRIPTION OF THE DRAWINGS

FIG. 1 is a perspective assembled view of the present invention;

FIG. 2 is a perspective exploded view of the present invention;

FIG. 3 shows that in a not bent state, the connecting bracket of the present invention is fitted through the connecting butt;

FIG. 4 shows that the connecting bracket of the present invention is fitted through the connecting butt and then bent;

FIG. 5 shows that in a not bent state, the temple of the present invention is fitted through the connecting butt;

FIG. 6 shows that the temple of the present invention is fitted through the connecting butt and then bent;

FIG. 7 shows that the transverse beam of the bridge of the present invention is bridged over the trough portion between the nose and the forehead of a user;

FIG. 8 shows that the temple of the present invention is stopped by the stopper section of the connecting bracket;

FIG. 9 is a perspective view of a pair of conventional rimless glasses; and

FIG. 10 shows that the nosepieces of the conventional rimless glasses are adjusted for adjusting the position of the lenses.

### DETAILED DESCRIPTION OF THE PREFERRED EMBODIMENTS

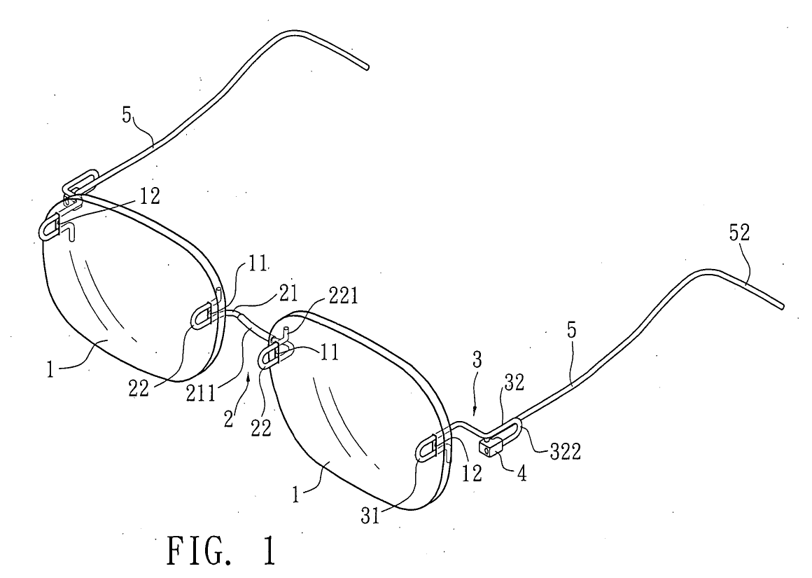

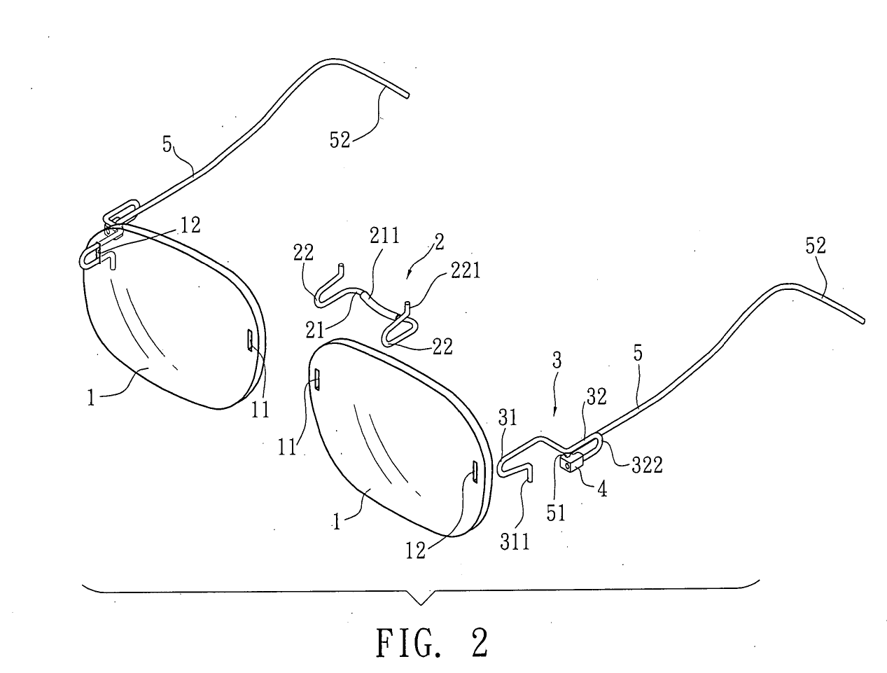

Please refer to FIGS. 1 to 6. The assembling structure of the glasses of the present invention includes two lenses 1. The adjacent inner sides of the lenses 1 are respectively formed with two first slots 11. The distal outer sides of the lenses 1 are respectively formed with two second slots 12.

The present invention further includes a bridge 2 made of a metal slender rod by bending. In this embodiment, the bridge 2 is made of titanium alloy. The bridge 2 has an arced transverse beam 21 on which a slipproof sleeve 211 is fitted. Two ends of the transverse beam 21 are bent to form two U-shaped insertion sections 22 for fitting through the first slots 11 of the lenses 1. The width of the opening of the U-shaped insertion section 22 is larger than the length of the first slot 11, whereby the insertion section 22 can be resiliently fixedly inserted in the first slot 11. Therefore, the two lenses 1 are interconnected by the bridge 2. In addition, a free end of the U-shaped insertion section 22 has a stopper end 221 for stopping the lens 1, whereby the insertion section 22 will not be over-fitted through the first slot 11.

The present invention further includes two connecting brackets 3. Each connecting bracket 3 is made of a metal slender rod by bending. In this embodiment, the connecting bracket 3 is made of titanium alloy. One end of the connecting bracket 3 is bent to form a U-shaped fixing section 31 for fitting through the second slot 12 of the lens 1. The width of the opening of the U-shaped fixing section 31 is larger than the length of the second slot 12, whereby the fixing section 31 can be resiliently fixedly inserted in the second slot 12. A free end of the U-shaped fixing section 31 has a stopper end 311 for stopping the lens 1, whereby the fixing section 31 will not be over-fitted through the second slot 12. The other end of the connecting bracket 3 is bent to form a U-shaped connecting end 32. A bight section of the U-shaped connecting end 32 forms a stopper section 322. In addition, two sides of a free end of the connecting end 32 are respectively formed with two protruding key sections 321.

The present invention further includes two connecting butts 4. Each connecting butt 4 is formed with a transverse first connecting hole 41 and a longitudinal second connecting hole 42. The first connecting hole 41 is formed on outer side of the connecting butt 4, while the second connecting hole 42 is formed on inner side of the connecting butt 4. The free end of the connecting end 32 of the connecting bracket 3 is fitted in the first connecting hole 41. A wall of the first connecting hole 41 is formed with two recesses 411 corresponding to the key sections 321 of the connecting end 32. Accordingly, the connecting butt 4 is fixed with the connecting end 32 of the connecting bracket 3. A tapered opening 421 is formed at one end of the second connecting hole 42.

The present invention further includes two temples 5. Each temple 5 is made of a metal slender rod by bending. In this embodiment, the temple 5 is made of titanium alloy. One end of the temple 5 is bent to form a longitudinal fitting section 51 for fitting into the second connecting hole 42 of the connecting butt 4. The free end of the fitting section 51 is formed with a tapered end 511 corresponding to the tapered opening 421 of the second connecting hole 42, whereby the temple 5 is pivotally connected with the connecting butt 4. The other end of the temple 5 is bent into a hook section 52 for hanging on a user's ear. A section of the temple 5 near the fitting section 51 will be stopped by the stopper section 322 of the connecting end 32 of the connecting bracket 3.

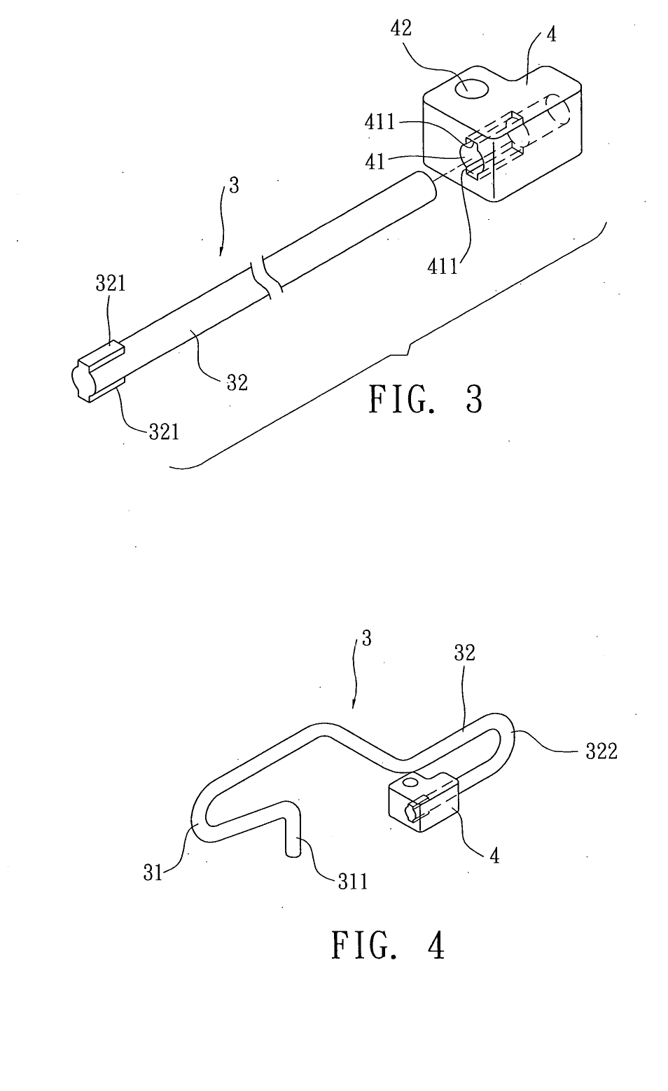

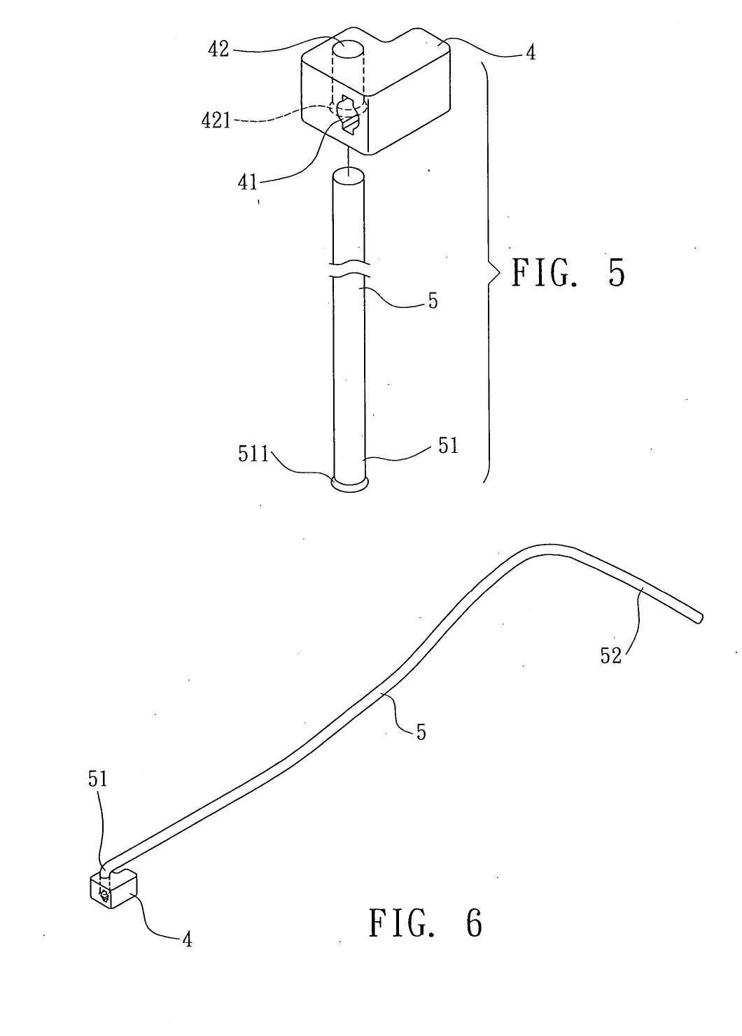

When assembled, the insertion sections 22 of the bridge 2 are respectively resiliently fitted through the first slots 11 of the lenses 1, whereby the lenses 1 are interconnected by the bridge 2. In a not bent state, as shown in FIG. 3, the end of the connecting bracket 3 free from the key sections 321 is fitted through the first connecting hole 41 of the connecting butt 4. After the key sections 321 are inserted in the recesses 411 of the first connecting hole 41, the connecting bracket 3 is sequentially bent to form the connecting end 32 and the fixing section 31 as shown in FIG. 4. Then the fixing section 31 of the connecting bracket 3 is resiliently fixedly fitted through the second slot 12 of the lens 1. Then, in a not bent state, as shown in FIG. 5, the end of the temple 5 free from the tapered end 511 is fitted through the second connecting hole 42 of the connecting butt 4. After the tapered end 511 is inserted in the tapered opening 421 of the second connecting hole 42, the temple 5 is bent to form the fitting section 51 and the hook section 52 as shown in FIG. 6. Accordingly, the two temples 5 are assembled with two sides of the lenses 1 to complete the assembly.

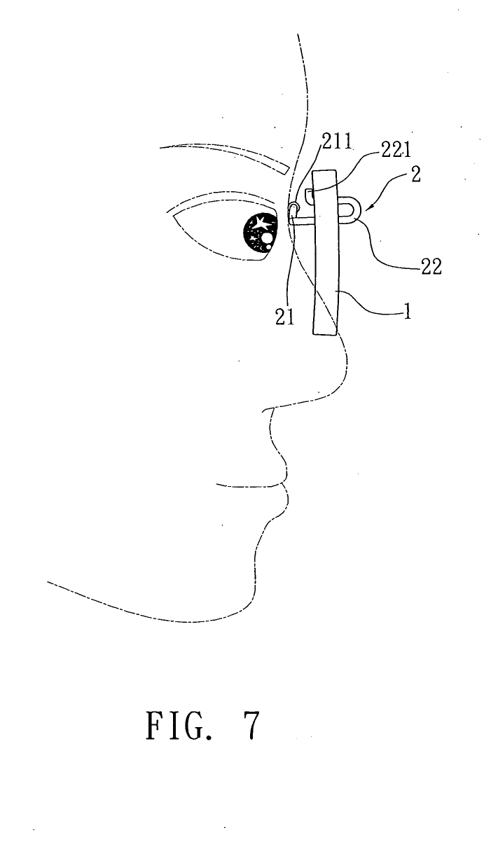

When wearing the glasses, the transverse beam 21 of the bridge 2 is directly bridged over the trough portion A between the nose and the forehead of a user as shown in FIG. 7. The lenses 1 are kept parallel to the eyes. The distance between the transverse beam 21 and the insertion section 22 is adjusted to space the lower edges of the lenses 1 from the eyes by a distance about the width of a finger. The hook sections 52 of the temples 5 are hung on the ears of the user, whereby the user can stably wear the glasses on his/her face.

With respect to a common person, the distances between the trough portion A and the eyes are equal. Therefore, when the transverse beam 21 of the bridge 2 is bridged over the trough portion A between the nose and the forehead of the user, the distance between the lenses 1 and the eyes will not change. Also, it is no more necessary to adjust the nosepieces according to the configuration of the nose as in the conventional glasses. Therefore, it is easy to wear the lenses 1 in a true position. Moreover, the user can wear the lenses 1 on his/her face without the nosepieces so that the uncomfortableness caused by the nosepieces can be eliminated.

Furthermore, the insertion section 22 of the bridge 2 and the fixing section 31 of the connecting bracket 3 both have stopper ends 221, 311. Therefore, when assembled, the insertion section 22 and the fixing section 31 will not entirely penetrate through the slots of the lenses.

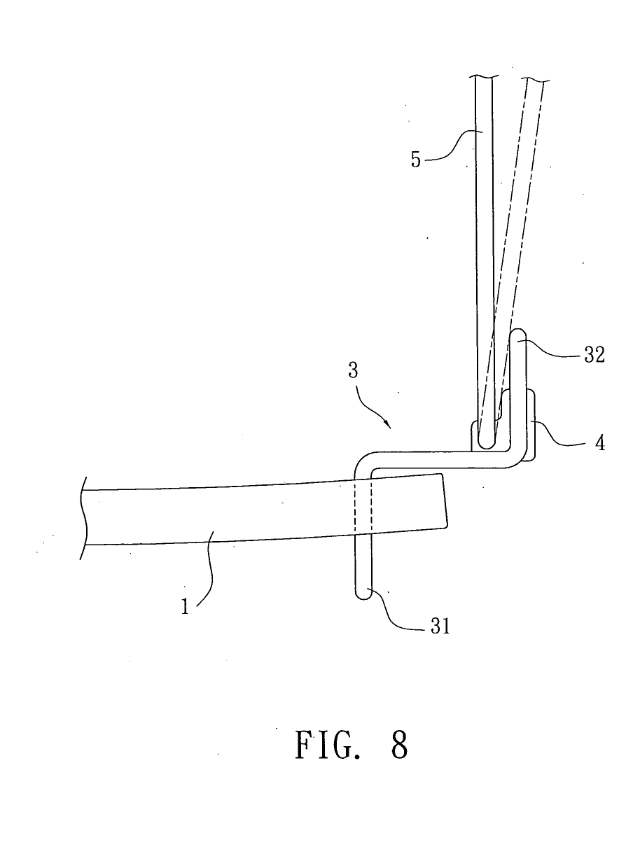

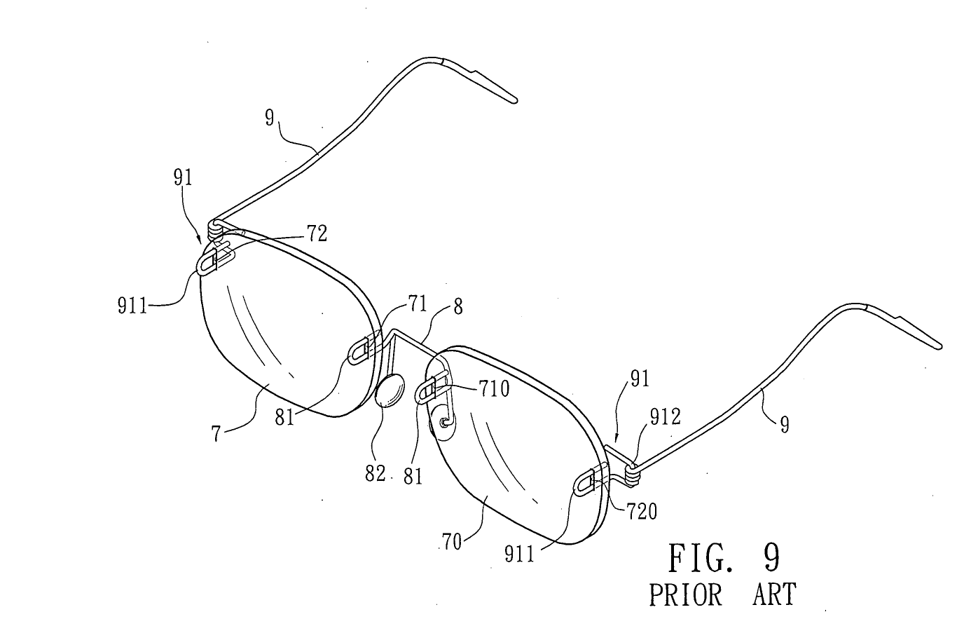

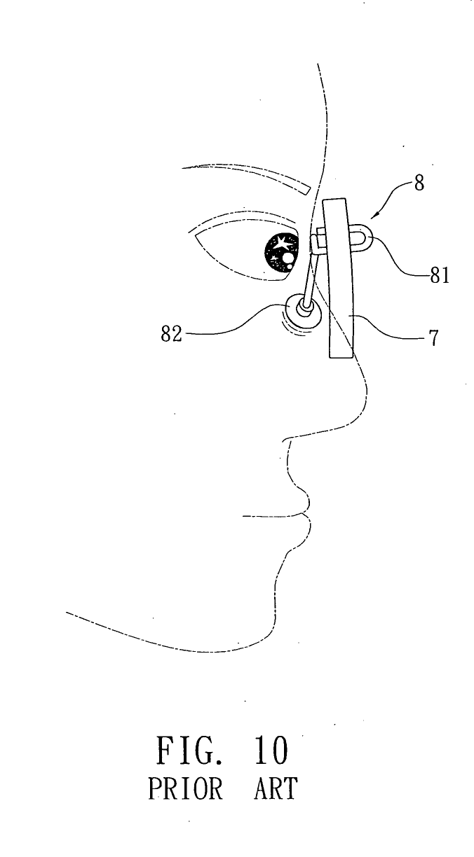

Besides, the first connecting holes 41 are formed on outer sides of the connecting butts 4, while the second connecting holes 42 are formed on inner sides of the connecting butts 4. Therefore, when assembling the connecting brackets 3 with the temples 5, the temples 5 are positioned on inner sides of the connecting brackets 3. Accordingly, the bodies of the temples 5 are stopped by the stopper sections 322 of the connecting ends 32 of the connecting brackets 3 as shown in FIG. 8. Therefore, the temples 5 will not be over-stretched outward so that the user can stably wear the glasses.

In addition, the temples 5 are connected with the connecting brackets 3 via the connecting butts 4. Accordingly, the lenses 1 can be assembled with the temples 5 with higher strength and firmness. Therefore, the user can more stably wear the glasses.

The above embodiments are only used to illustrate the present invention, not intended to limit the scope thereof. Many modifications of the above embodiments can be made without departing from the spirit of the present invention.

1. An assembling structure of a pair of glasses, comprising:
two lenses, two adjacent inner sides of the lenses being respectively formed with two first slots, the distal outer sides of the lenses being respectively formed with two second slots;
a bridge made of a metal slender rod by bending, the bridge having an arced transverse beam on which a slipproof sleeve is fitted, two ends of the transverse beam being bent to form two U-shaped insertion sections for fixedly fitting through the first slots of the lenses, whereby the two lenses are interconnected by the bridge;
two connecting brackets, each connecting bracket being made of a metal slender rod by bending, one end of the connecting bracket being bent to form a U-shaped fixing section for fixedly fitting through the second slot of the lens, the other end of the connecting bracket being bent to form a U-shaped connecting end, a bight section of the U-shaped connecting end forming a stopper section;
two connecting butts, each connecting butt being formed with a transverse first connecting hole and a longitudinal second connecting hole, the first connecting hole being formed on outer side of the connecting butt, while the second connecting hole being formed on inner side of the connecting butt, a free end of the connecting end of the connecting bracket being fixedly fitted in the first connecting hole, whereby the connecting butt is fixed with the connecting end of the connecting bracket; and
two temples, each temple being made of a metal slender rod by bending, one end of the temple being bent to form a longitudinal fitting section for fitting into the second connecting hole of the connecting butt, whereby the temple is pivotally connected with the connecting butt, the other end of the temple being bent into a hook section for hanging on a user's ear, a section of the temple near the fitting section being stoppable by the stopper section of the connecting end of the connecting bracket.

2. The assembling structure of the glasses as claimed in claim 1, wherein the opening of the U-shaped insertion section has a width larger than a length of the first slot, whereby the insertion section can be resiliently fixedly inserted in the first slot.

3. The assembling structure of the glasses as claimed in claim 1, wherein a free end of the U-shaped insertion section of the bridge has a stopper end.

4. The assembling structure of the glasses as claimed in claim 1, wherein the opening of the U-shaped fixing section of the connecting bracket has a width larger than a length of the second slot, whereby the fixing section can be resiliently fixedly inserted in the second slot.

5. The assembling structure of the glasses as claimed in claim 1, wherein a free end of the U-shaped fixing section of the connecting bracket has a stopper end.

6. The assembling structure of the glasses as claimed in claim 1, wherein two sides of a free end of the connecting end are respectively formed with two protruding key sections, a wall of the first connecting hole of the connecting butt being formed with two recesses corresponding to the key sections of the connecting end.

7. The assembling structure of the glasses as claimed in claim 1, wherein a tapered opening is formed at one end of the second connecting hole of the connecting butt, a free end of the fitting section of the temple being formed with a tapered end corresponding to the tapered opening of the second connecting hole.

8. The assembling structure of the glasses as claimed in claim 1, wherein the other end of the temple is bent into a hook section for hanging on a user's ear.

9. The assembling structure of the glasses as claimed in claim 1, wherein the bridge, the connecting brackets and the temples are all made of titanium alloy.

10. The assembling structure of the glasses as claimed in claim 1, wherein the sleeve fitted on the transverse beam is made of plastic material.
